(19) United States
(12) Patent Application Publication
(10) Pub. No.: US 2019/0114517 A1
(43) Pub. Date: Apr. 18, 2019

(54) MITIGATION OF PRINT BANDING USING A SINGLE USER-CONTROLLABLE PARAMETER

(71) Applicant: XEROX CORPORATION, Norwalk, CT (US)

(72) Inventors: DOUGLAS DEAN DARLING, PORTLAND, OR (US); ERIC HYDE, PORTLAND, OR (US); WALTER SEAN HARRIS, PORTLAND, OR (US); BRIAN J. DANIELS, LAKE OSWEGO, OR (US); REID W. GUNNELL, WILSONVILLE, OR (US); NASSER ALAVIZADEH, TIGARD, OR (US); LISA M. SCHMIDT, PORTLAND, OR (US); ROBERT MARK JACOBS, TIGARD, OR (US)

(21) Appl. No.: 15/786,076

(22) Filed: Oct. 17, 2017

(51) Int. Cl. G06K 15/12; B41J 29/393

(52) U.S. Cl. CPC G06K 15/1219; B41J 29/393

(57) ABSTRACT

A method of correcting print banding in a printer, including initiating the banding correction process, generating prints with various levels of banding based on different levels of voltages applied to the array of jets, receiving an input from the user selecting the preferred print, and adjusting voltage levels applied to jets corresponding to the preferred print.

### TECHNICAL FIELD

This disclosure relates to printing systems, more particularly to printing systems that adjust for banding artifacts.

### BACKGROUND

Ink jet printers typically have intensity variations. These may result from variations in the manufacturing process, the assembly of the printhead, or other factors like operating parameters. During manufacture, a normalization process typically mitigates the variations by adjusting the operating parameters to proactively account for the variations. Customer prints generated after initial installation will typically not have banding artifacts.

Once the printer operates in the field, it may develop banding, an artifact in which the intensity variations form noticeable bands across the printed image. This may occur because individual inkjets in the array of jets do not age at the same rate. The artifacts may reach a point where they become objectionable to the customer.

A previous solution to this involves adjusting spatial tone reproduction (or response) curves (TRCs). A TRC maps a desired output value to the actual print values generated by the ink jet printhead. Adjusting the TRC map can be an effective way to compensate for banding that develops during the life of a printhead. However, to use a TRC map to mitigate banding that changes over the life of a printhead, the customer's system must have the ability to scan images to measure intensity on a jet by jet basis. There is a need for a process to correct for banding in systems which do not have the ability to scan and measure individual jet intensity.

### SUMMARY

A first embodiment is a printer having a controller to send signals to a printhead, a printhead to receive signals from the controller and to produce prints based upon those signals, a memory to store normalization data for jets in the printhead, wherein the controller adjusts the signals sent to each jet of the printhead based upon the normalization data, a user interface to allow a user to communicate with the controller, wherein at least one of the communications is a signal to start a banding correction process, wherein the banding process causes the controller to execute code to: adjust the normalization data for jets in the printhead to produce multiple set of adjusted data; send the adjusted data to the printhead; produce a print for each set of the adjusted data; send a query to the user interface to allow the user to select a desired print; altering the normalization data to match the adjusted data corresponding to the desired print; and storing the altered data.

A method of correcting banding in a printer includes initiating banding correction, generating a series of prints, each print having a different level of banding, wherein the different levels of banding correspond to different levels of voltages applied to an array of jets, receiving an input from a user selecting a print, selecting a banding parameter corresponding to the selected print, and adjusting voltage levels applied to the jets to account for the banding parameter.

### BRIEF DESCRIPTION OF THE DRAWINGS

FIG. 1 shows an embodiment of a jet normalization.

FIG. 2 shows an illustration of intensity variations that develop over life.

FIG. 3 illustrates intensity variation reduced to its smallest repeating pattern.

FIG. 4 shows an embodiment of a print system.

FIG. 5 shows a flowchart of an embodiment of a banding correction process.

FIG. 6 shows a graph of adjustments based upon column locations of jets.

FIG. 7 shows examples of banding prints in a minus direction from a starting position.

FIG. 8 shows examples of banding prints in a positive direction from a starting position.

### DETAILED DESCRIPTION OF THE EMBODIMENTS

As used here, the term “printer” generally refers to an apparatus that applies an ink to print media and can encompass any apparatus, such as a digital copier, book-making machine, facsimile machine, multi-function machine, etc., which performs a print outputting function for any purpose. “Print media” or “substrate” can be a physical sheet of paper, plastic, or other suitable physical substrate suitable for receiving ink images, whether precut or web fed. As used in this document, “ink” refers to a colorant that is liquid when applied to an image receiving member. For example, ink can be aqueous ink, ink emulsions, melted phase change ink, or gel ink that has been heated to a temperature that enables the ink to be liquid for application or ejection onto an image receiving member and then return to a gelatinous state. A printer can include a variety of other components, such as finishers, paper feeders, and the like, and can be embodied as a copier, printer, or a multifunction machine. An image generally includes information in electronic form, which is to be rendered on print media by a marking engine and can include text, graphics, pictures, and the like.

The term “printhead” as used herein refers to a component in the printer that is configured to eject ink drops onto the image receiving member. A typical printhead includes a plurality of ink ejectors, or inkjets, that are configured to eject ink drops of one or more ink colors onto the image receiving member. The ink ejectors are arranged in an array of one or more rows and columns. In some embodiments, the ink ejectors are arranged in staggered diagonal rows across a face of the print head. Various printer embodiments include one or more printheads that form ink images on the image receiving member. Some printer embodiments include a plurality of printheads arranged in a print zone. Print media moves past the printheads in a process direction through the print zone. An individual jet in a printhead ejects ink drops that form a line, or pattern, extending in the process direction as the image receiving surface moves past the print head in the process direction. The plurality inkjets, or jets, in the printhead are used to make patterns in a cross-process direction, which is perpendicular to the process direction across the image receiving member.

The printhead receives control signals from a controller that determines which jets deposit ink and which ones do not. The term “controller” as used here means any controller, microcontroller, processor, application specific integrated circuit (ASIC), or logic circuitry that can execute programmable instructions to control operation of the print head. The signals to the print head generally take the form of voltages. The voltages stimulate actuators to cause a jet to eject a drop of ink, or may only partially stimulate an actuator to cause the ink in a jet to move but not eject. The embodiments here only address the voltages that stimulate an actuator to cause the jet to eject ink. The controller also applies the jet normalization values to each jet as required to achieve uniform drop volume and velocity.

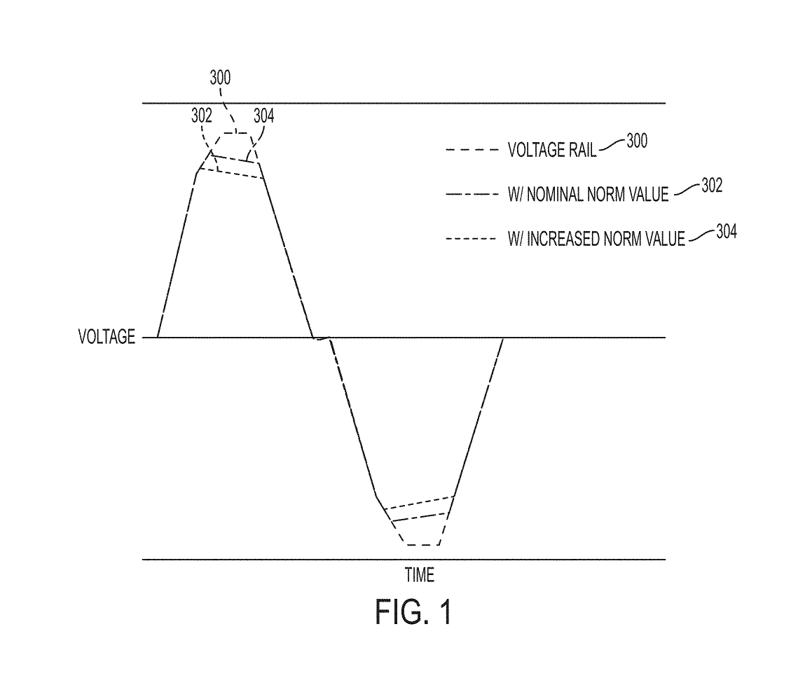

During manufacture of a print system, the print head typically undergoes a normalization process to adjust the voltage waveform for each jet. The normalization process compensates for manufacturing variations between printheads and jet-jet variation within the printhead. FIG. 1 illustrates an example driving waveform for an inkjet. In this embodiment, first the overall, or “rail,” voltage 300 is set for the voltage driving waveform in the printhead to set the correct overall drop volume of the printhead. Then, individual jets are given normalization values to compensate for jet-jet variation. The normalization value determines where the waveform will be truncated at 302 for a given inkjet. Individual jets are tested at various normalization, or “norm” values 304 to determine what level causes the jet to fire with the best velocity and drop volume. In one embodiment 64 normalization values are used. The normalization process then stores the rail voltage and normalization values for each jet in a memory in the print system.

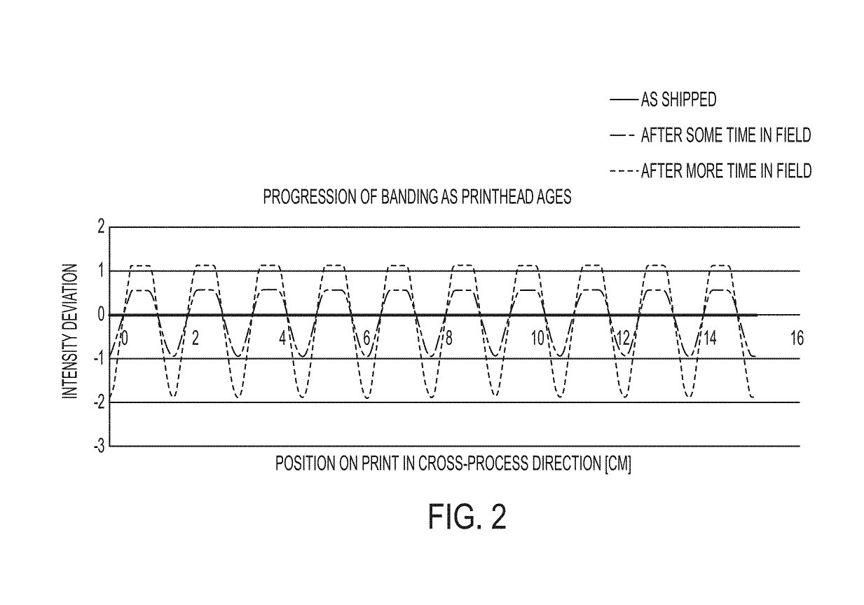

Over time, the jets age. Not all jets age at the same rate. FIG. 2 illustrates an example of non-uniform aging. As shipped there will be no significant variation in intensity across the print, since the printhead was just normalized. Variations in aging typically have both a random and a systemic component. The random component does not typically result in noticeable artifacts to the consumer. The systemic component can result in artifacts that are noticeable to the customer. The systemic component may correlate to the system architecture or arrangement and may result in an artifact called banding, where the intensity variations form bands within the printed image.

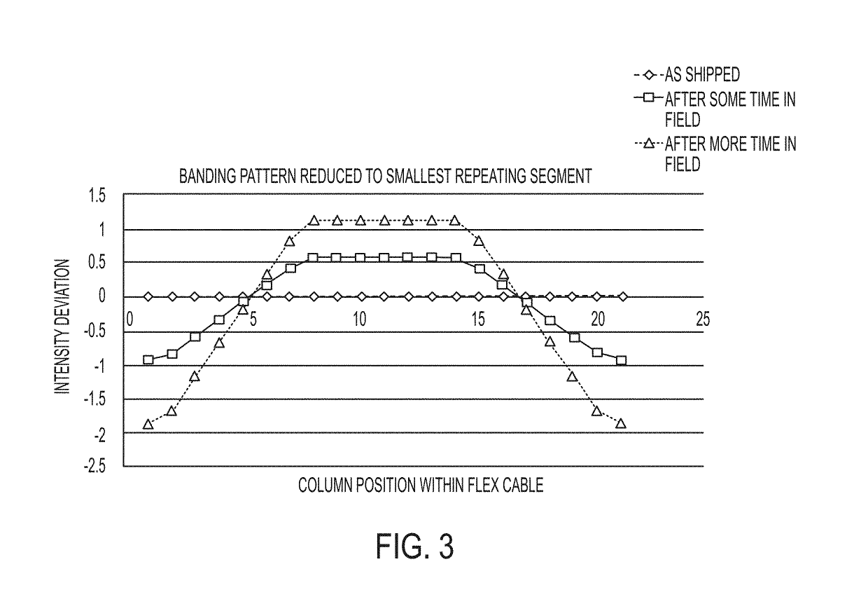

FIG. 3 shows one example of a banding in printhead, where the controller connects to the printhead by flexible cables, or “flex cables.” The columns of jets that reside to the outer edges of the flex cables tend to age faster than those near the center of the flex cables. In that example the banding correlates to the column position within each flex cable, and the pattern is repeated across the printhead for each flex cable. In another example, the aging rate may be different for jets near the upper or lower edges of the array of jets. In yet another example, aging may be different for jets depending on their location within the internal fluidic manifold structure. The differences in aging may result in banding that correlates with the geometry of the printhead in a predictable manner.

The repeatable banding signature for a particular printhead design may be determined by inspection and analysis of the geometry or by empirical testing of multiple printheads with the same design, or both. In the embodiment described above, the signature was a repeating pattern. But, in other embodiments, the banding signature may not be repeating, as in the case of a printhead that is controlled by one large flex cable, rather than several discrete flex cables. Once the repeatable signature is determined, the print system can use that knowledge to compensate for banding.

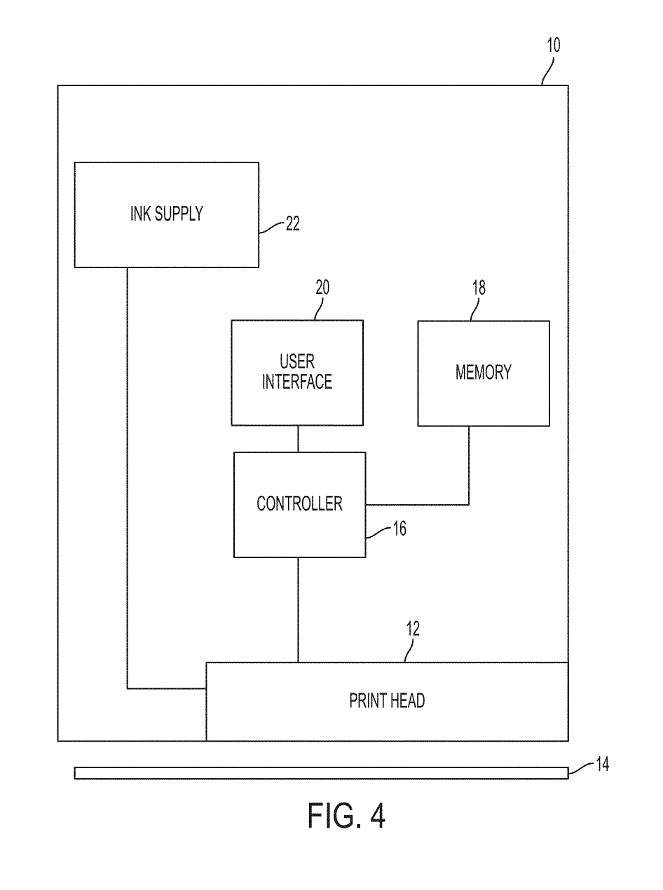

FIG. 4 shows an embodiment of a print system 10. The print system has a printhead 12 with an array of jets to deposit ink on print media or substrate 14. The printhead 12 responds to signals from the controller 16 to deposit ink on the substrate or not. The print head receives ink from a supply 22.

In the embodiments shown here, a user or consumer detects the banding artifact and uses a user interface 20 to begin the banding correction process. The user interface may consist of a display screen and some sort of user input device, such as buttons or a touch screen. For example, the print system may have a way to allow users to select print options, etc., through the user interface.

The print system of the embodiments here includes a memory 18. The memory may store instructions to be executed by the processor, as well as information regarding other print parameters such a paper size, resolution, color selection, etc. In addition, the memory will include the normalization values discussed earlier, as well as other data used to generate prints demonstrating different banding parameter settings.

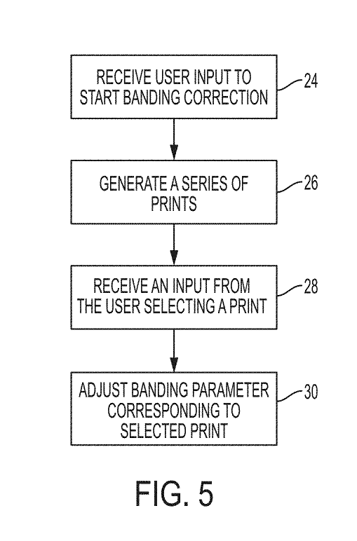

FIG. 5 shows an embodiment of a banding correction process. Once a user has noticed banding artifacts, the user can employ the user interface to start a banding correction process at 24. Typically, user systems may not have the ability to scan an image to detect banding artifacts. However, if the system does have such a capability, the user interface may not be needed to start the banding correction process.

In response to either the user input or the system automatic start, the controller generates a series of print data sets, each corresponding to a different banding parameter at 26. The user then reviews the prints and selects a desired print that has the lowest noticeable banding at 28. The system then adjusts the values in the normalization data to account for the new banding parameter at 30. This process may be repeated as often as needed.

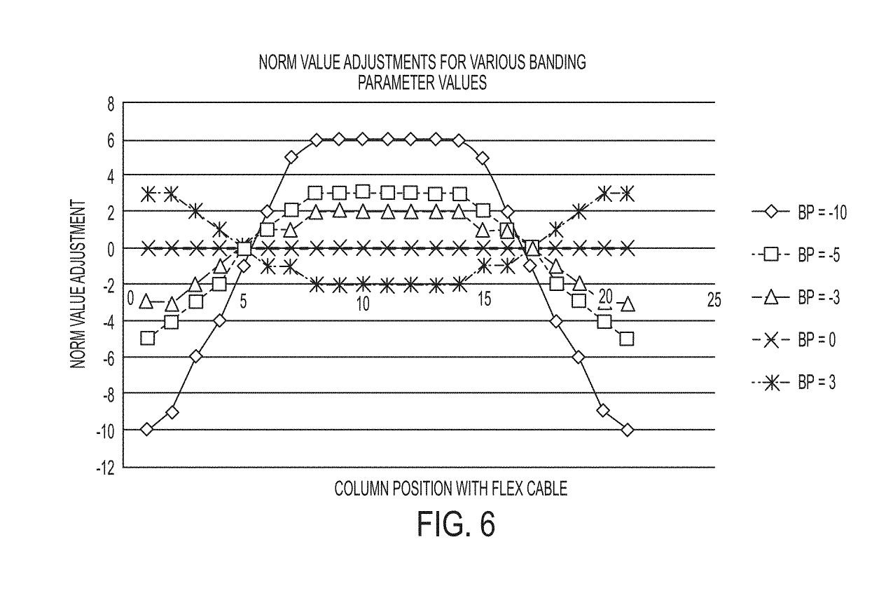

FIG. 6 shows an example of the pattern for norm value adjustments. The pattern for norm value adjustments match the predictable pattern of banding that was determined as described above. FIG. 6 is a continuation of the example where banding correlated to the column position of the jets within the flex cable. As the banding parameter is changed, the pattern stays the same, but the magnitude is scaled by the value of the banding parameter. The scaling factor, or banding parameter, can be either positive or negative or zero. In this embodiment, the normalization values were restricted to be integers. In other embodiments, decimal values could be used, depending on the process for normalization. In the embodiment shown in FIG. 6, the outer columns on both sides of the flex cables are adjusted by the banding parameter. FIG. 6 shows the pattern for norm value adjustments for Banding Parameters (BP) of −10, −5, −3, 0, and, +3.

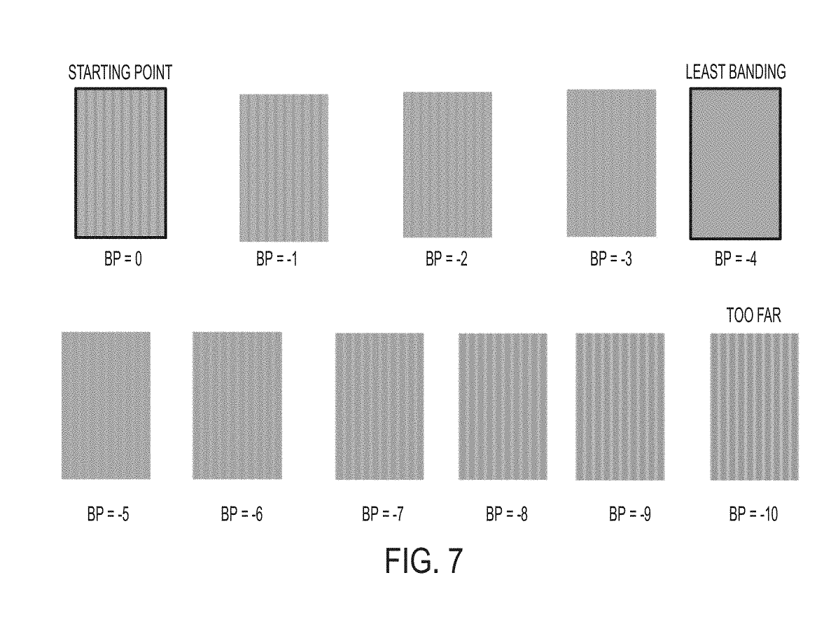

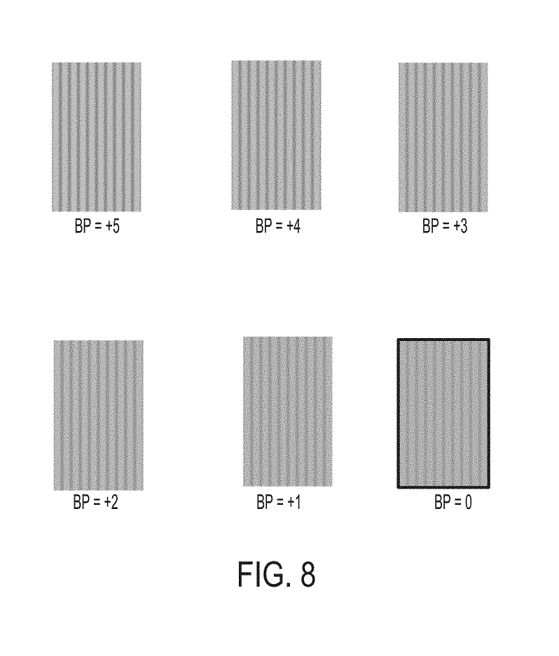

As the banding correction process proceeds, a set of prints is made for various levels of the Banding Parameter. For each value of Banding Parameter, the corresponding normalization adjustment is determined for each jet. Then a print is made using normalization values for each jet by adding the adjustment to the original normalization value of that jet. FIGS. 7 and 8 show the resulting prints based upon different Banding Parameters adjustments. FIG. 7 shows resulting prints starting at 0 adjustments and negative values of banding parameter. FIG. 7 shows a range of Banding Parameters from 0 to −10. FIG. 8 shows resulting prints from positive Banding Parameters in the range from 0 to +5. In this example, BP=0 is the state of the printer at the start of the process. After making prints at various levels of Banding Parameters, the user can examine the prints and select the Banding Parameter that results in prints with the least banding. In the example shown in FIGS. 7 and 8, positive values of BP made banding worse, negative values of BP reduced banding until BP=−4, beyond BP=−4, banding became worse again. The least banding was achieved at BP=−4. After the user determines the preferred value of BP, the user inputs that preferred value of Banding Parameter into the print system, and the system will store and use new normalization values for each jet, based on that value of Banding Parameter, for all prints going forward.

In this manner, a user can perform a banding correction without any need for intensity scanning or technical expertise. The print system can adjust for banding as often as needed to ensure that users can make clean prints. In addition, the process may be performed on one color at different dithering percentages, or with multiple print sets for each color at different dithering levels.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method of correcting banding in a printer, comprising:
initiating banding correction;
generating a series of prints, each print having a different level of banding, wherein the different levels of banding correspond to different levels of voltages applied to an array of jets;
receiving an input from a user selecting a print;
selecting a banding parameter corresponding to the selected print; and
adjusting voltage levels applied to the jets to account for the banding parameter.

2. The method of claim 1, wherein initiating banding correction comprises receiving a user input to initiate banding correction.

3. The method of claim 1, wherein initiating banding correction comprises:
generating a print;
scanning the print for intensity; and
identifying a banding artifact.

4. The method of claim 1, wherein the different levels of voltage correspond to discrete voltage levels.

5. The method of claim 1, wherein the series of prints represent voltage levels both higher and lower than a current voltage.

6. The method of claim 1, wherein the series of prints include prints at different dither percentages of a single color.

7. The method of claim 1, wherein the series of prints include prints at different dither percentages of multiple colors.

8. The method of claim 1, wherein the method is repeatable as needed.

9. A printer, comprising:
a controller to send signals;
a printhead to receive signals from the controller and to produce prints based upon those signals;
a memory to store normalization data for jets in the printhead, wherein the controller adjusts the signals sent to each jet of the printhead based upon the normalization data;
a user interface to allow a user to communicate with the controller, wherein at least one of the communications is a signal to start a banding correction process, wherein the banding process causes the controller to execute code to:
adjust the normalization data for jets in the printhead to produce multiple set of adjusted data;
send the adjusted data to the printhead;
produce a print for each set of the adjusted data;
send a query to the user interface to allow the user to select a desired print;
altering the normalization data to match the adjusted data corresponding to the desired print; and
storing the altered data.

10. The printer of claim 9, wherein the controller comprises one of a microcontroller, processor, ASIC, or logic circuitry.

11. The printer of claim 9, wherein the different levels of voltage correspond to discrete voltage levels.

12. The printer of claim 9, wherein the print for each set of the adjusted data represents voltage levels both higher and lower than a current voltage.

13. The printer of claim 9, wherein the print for each set of the adjusted data represents different dither percentages of a single color.

14. The printer of claim 9, wherein the print for each set of the adjusted data includes prints at different dither percentages of multiple colors.
